(19) United States
(12) Patent Application Publication
(10) Pub. No.: US 2008/0060028 A1
(43) Pub. Date: Mar. 6, 2008

(54) REMOTE CONTROL DEVICE AND AUTOMATIC SWITCHING METHOD USING THE SAME

(75) Inventor: Ming-Chou Chiang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,760

(22) Filed: Dec. 29, 2006

(30) Foreign Application Priority Data
Aug. 30, 2006 (CN) 200610062377.5

(51) Int. Cl. H04N 7/173; H04N 7/18; H04N 5/44

(52) U.S. Cl. 725/88; 348/734; 725/102; 725/78

(57) ABSTRACT

A remote control device for controlling a media renderer is provided, the remote control device includes a wireless personal area network module and a wireless local area network module. The wireless personal area network module includes a receiving module and a determining module. The receiving module receives a packet from the media renderer. The determining module determines whether the remote control device roams according to the packet. The wireless local area network module includes a control module. The control module controls another media renderer to play from a paused position according to the paused information when the remote control device roams. An automatic switching method is also provided.

### BACKGROUND OF THE INVENTION

1. Field of the Invention

The invention generally relates to a device and method, and particularly to a remote control device and automatic switching method using the same.

2. Description of Related Art

With fast development of multimedia technology, wireless home networks including media servers, media renderers, remote controllers and so on are become increasingly popular. In a typical wireless home network environment, as a user carrying a remote controller leaves his/her bedroom equipped with a media renderer and enters his/her living room equipped another media renderer, if he/her still expects to continue watching a TV program played in the bedroom, he/she has to remember a paused position of the TV program in advance, uses his/her remote controller to switch on the media renderer in the living room, and then fast forward to the paused position. Obviously, this operation is quite time-consuming, inconvenient and bothersome.

Therefore, a heretofore unaddressed need exists in the industry to overcome the aforementioned deficiencies and inadequacies.

### SUMMARY OF THE INVENTION

A remote control device for controlling a media renderer is provided, the remote control device includes a wireless personal area network module and a wireless local area network module. The wireless personal area network module includes a receiving module and a determining module. The receiving module receives a packet from the media renderer. The determining module determines whether the remote control device roams according to the packet. The wireless local area network module includes a control module. The control module controls another media renderer to play from a paused position according to the paused information when the remote control device roams.

An automatic switching method applicable to a remote control device is also provided. The automatic switching method includes: receiving a packet from a media renderer; determining whether the remote control device roams according to the packet; storing paused information of the media renderer if the remote control device roams; and playing from a paused position according to the paused information of another renderer.

Other advantages and novel features will become more apparent from the following detailed description when taken in conjunction with the accompanying drawings, in which:

### BRIEF DESCRIPTION OF THE DRAWINGS

FIG. 1 is a block diagram of a wireless home network system of an exemplary embodiment of the invention;

FIG. 2 is a block diagram of the remote control device 100 in FIG. 1;

FIG. 3 is a flowchart of an automatic switching method of another exemplary embodiment of the invention;

FIG. 4 is a detailed flowchart of FIG. 3;

FIG. 5 is a detailed flowchart of FIG. 4; and

FIG. 6 is a detailed flowchart of step S517 in FIG. 5.

### DETAILED DESCRIPTION OF THE INVENTION

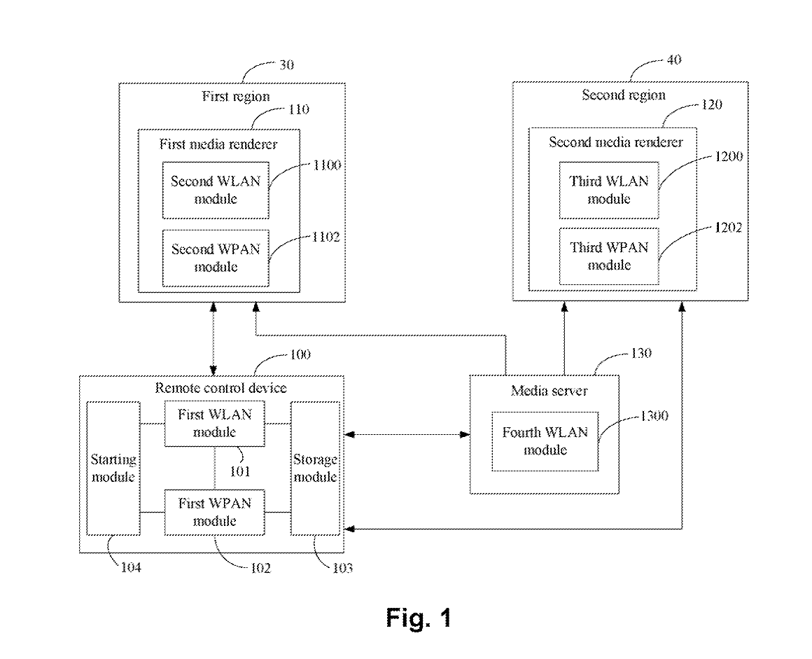

FIG. 1 is a block diagram of a wireless home network system 10 of an exemplary embodiment of the invention. The wireless home network system 10 includes a remote control device 100, a first media renderer 110, a second media renderer 120, and a media server 130.

The remote control device 100 automatically switches between the first media renderer 110 and the second media renderer 120. In this embodiment, the remote control device 100 is a control point, and includes a first wireless local area network (WLAN) module 101, a first wireless personal area network (WPAN) module 102, a storage module 103, and a starting module 104.

The first media renderer 110 is located in a first region 30, and includes a second WLAN module 1100 and a second WPAN module 1102. In this embodiment, the first region 30 is a living room.

The second media renderer 120 is located in a second region 40, and includes a third WLAN module 1200 and a third WPAN module 1202. In this embodiment, the second region 40 is a bedroom.

The media server 130 includes a fourth WLAN module 1300.

The first WPAN module 101 may communicate with the second WLAN module 1100, the third WLAN module 1200, and the fourth WLAN module 1300 via an Institute of Electrical and Electronics Engineers (IEEE) 802.11 protocol, and the first WPAN module 102 may communicate with the second WPAN module 1102 and the third WPAN module 1202 via a Zigbee protocol or a Bluetooth protocol.

As the remote control device 100 is located in a same room as the first media renderer 110 or the second media renderer 120, the remote control device 100 may control the first media renderer 110 or the second media renderer 120 via the Zigbee protocol or the Bluetooth protocol, as the remote control device 100 is located in a different room from the first media renderer 110 or the second media renderer 120, the remote control device 100 may control the first media renderer 110 or the second media renderer 120 via the IEEE 802.11 protocol.

The storage module 103 is connected to the first WPAN module 101 and the first WPAN module 102 for storing information. In this embodiment, the information includes basic information of the first media renderer 110 and the second media renderer 120, along with paused information of the first media renderer 110 or the second media renderer 120 when the remote control device 100 roams between the first region 30 and the second region 40. The basic information is listed in a mapping table below, and includes a unique device name (UDN) based on a universally-unique identifier (UUID) field, a device name field, and a MAC address field.

Mapping table

| UDN | Device name | MAC address |
|---|---|---|
| C815037a-f246-4a2f- | First media renderer | 0x0000BD1268ED151E |
| a107-0df8fb855d2c | | |
| 1de35a4b-b5d6-4fab- | Second media renderer | 0x0000BD1268ED1C12 |
| 952b-318357895e07 | | |

The starting module 104 is connected to the first WLAN module 101 and the first WPAN module 102 for switching on or off the first WLAN module 101 and the first WPAN module 102.

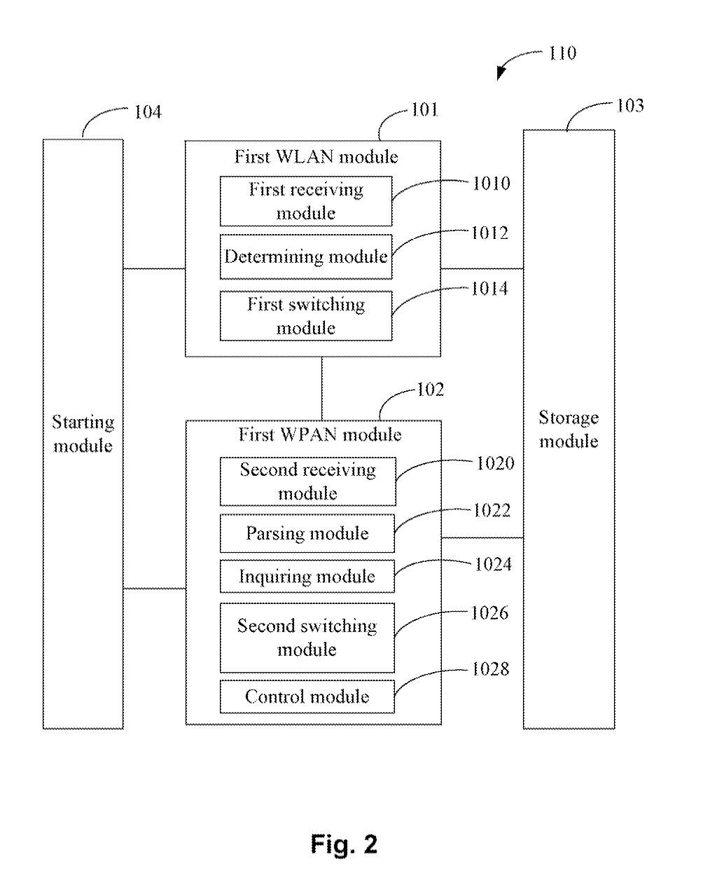

FIG. 2 is a block diagram of the remote control device 100 in FIG. 1.

The first WPAN module 101 includes a first receiving module 1010, a determining module 1012, and a first switching module 1014. The first WLAN module 102 includes a second receiving module 1020, a parsing module 1022, an inquiring module 1024, a second switching module 1026, and a control module 1028.

The first receiving module 1010 receives a packet from the first media renderer 110 or the second media renderer 120, and obtains media information from the packet. In this embodiment, the media information includes paused information of the first media renderer 110 or the second media renderer 120.

The determining module 1012 determines whether the remote control device 100 roams according to the packet. In this embodiment, the determining module 1012 compares a signal strength of the packet with a preset signal strength, to determine whether the remote control device 100 roams. For example, if the signal strength of the packet from the first media renderer 110 is lower than the preset signal strength, it indicates that the remote control device 100 is leaving or has left its original region. If the signal strength of the packet from the second media renderer 120 is greater than the preset signal strength, it indicates that the remote control device 100 is entering or has entered the second region.

The first switching module 1014 transmits a short distance switch-on instruction or a short distance switch-off instruction.

The second receiving module 1020 receives a packet from the first media renderer 110 or the second media render 120, and obtains media information from the packet. In this embodiment, the media information includes address information of the first media renderer 110 or the second media renderer 120, and the address information is a medium access control (MAC) address

The parsing module 1022 parses the media information and stores the media information into the storage module 103.

The inquiring module 1024 determines a media renderer transmitting the packet according to the media information. In this embodiment, the inquiring module 1024 queries the mapping table in the storage module 103 for a name of the media renderer transmitting the packet according to the UDN thereof, which is indicated in a header field of the packet.

The second switching module 1026 transmits a long-distance switch-on instruction or a short-distance switch-off instruction.

The control module 1028 controls the second media renderer 120 to play from the paused position according to the paused information. For example, if the remote control device 100 roams from the first region 30 to the second region 40, the control module 1028 controls the second media renderer 120 to play from the paused position.

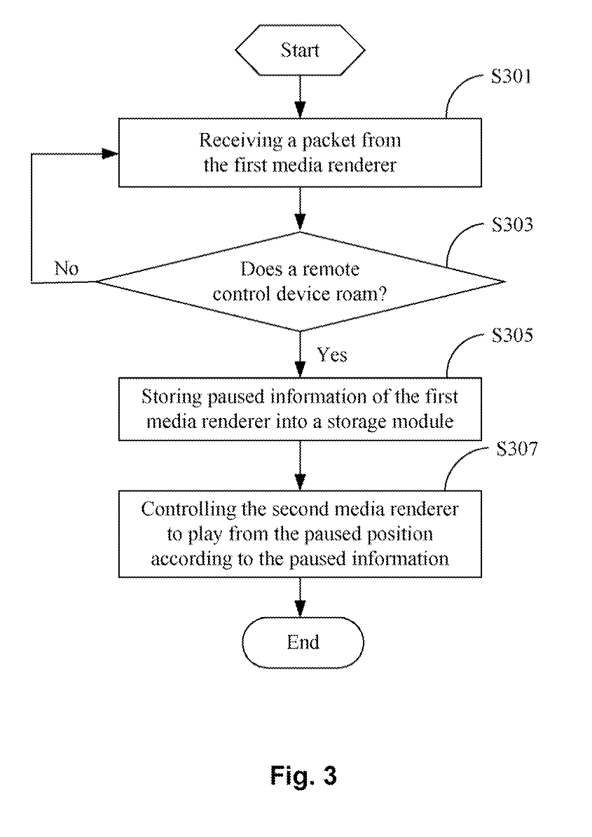

FIG. 3 is a flowchart of an automatic switching method of another exemplary embodiment of the invention.

In step S301, the remote control device 100 receives a packet from the first media renderer 110.

In step S303, the remote control device 100 determines whether the remote control device 100 roams according to the packet. In this embodiment, the remote control device 100 determines whether the remote control device 100 roams from the first region 30 to the second region 40. If the remote control device 100 roams from the first region 30 to the second region 40, the process proceeds to step S305, otherwise the process returns to step S301.

In step S305, the remote control device 100 stores paused information of the first media renderer 110 into the storage module 103.

In step S307, the remote control device 100 controls the second media renderer 110 to play from the paused position according to the paused information.

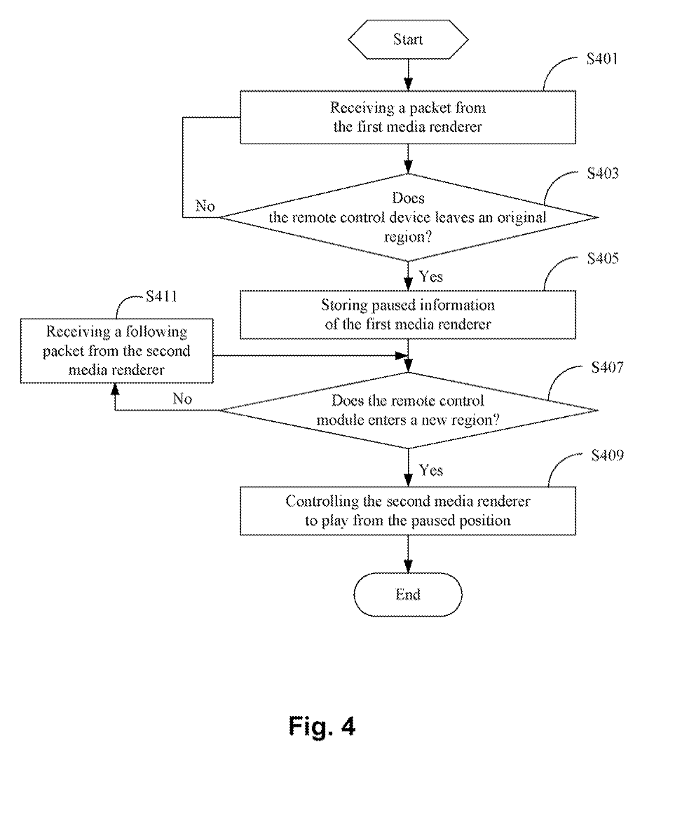

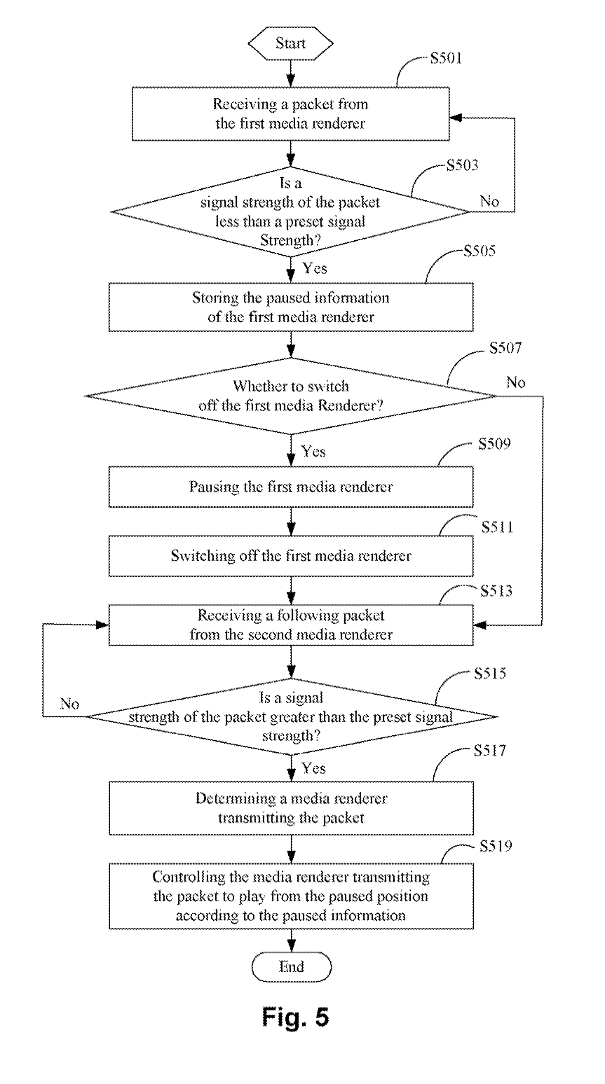

FIG. 4 is a detailed flowchart of FIG. 5.

In step S401, the remote control device 100 receives a packet from the first media renderer 110.

In step S403, the remote control device 100 determines whether the remote control device 100 leaves an original region according to the packet. In this embodiment, the remote control device 100 determines whether the remote control device 100 leaves the first region 30 by comparing a signal strength of the packet with a preset signal strength. If the signal strength of the packet is less than the preset signal strength, that Indicates the remote control device 100 is leaving or has left the first region 30, and the process proceeds to step S405, otherwise the process returns step S301.

In step S405, the remote control module 100 stores paused information of the first media renderer 110.

In step S407, the remote control module 100 determines whether the remote control module 100 enters the second region 40. If the remote control module 100 enters the second region 40, the process proceeds to step S409, otherwise the process proceeds to step S 411.

In step S409, the remote control module 100 controls the second media renderer 120 to play from the paused position according to the paused information.

In step S411, the remote control module 100 receives a following packet from the second media renderer 120.

FIG. 5 is a detailed flowchart of FIG. 4.

In step S501, the remote device 100 receives a packet from the first media renderer 110.

In step S503, the remote device 100 determines whether a signal strength of the packet is less than a preset signal strength. If the signal strength of the packet is less than the preset signal strength, the process proceeds to step S505, otherwise the step returns to step S501.

In step S505, the remote control module 100 stores paused information of the first media renderer 110.

In step S507, the remote control module 100 determines whether to switch off the first media renderer 110. If the remote control module 100 determines to switch off the first media renderer 110, the process proceeds to step S509, otherwise the process proceeds to step S513.

In step S509, the remote control module 100 pauses the first media renderer 110.

In step S511, the remote control module 100 switches off the first media renderer 110.

In step S513, the remote control module 100 receives a following packet from the first media renderer 110.

In step S515, the remote control module 100 determines whether a signal strength of the packet is greater than the preset signal strength. If the signal strength of the packet is greater than the preset signal strength, the process proceeds to step S517, otherwise the step returns to step S513.

In step S517, the remote control module 100 determines a media renderer transmitting the packet.

In step S519, the remote control module 100 controls the media renderer transmitting the packet to play from the paused position according to the paused information.

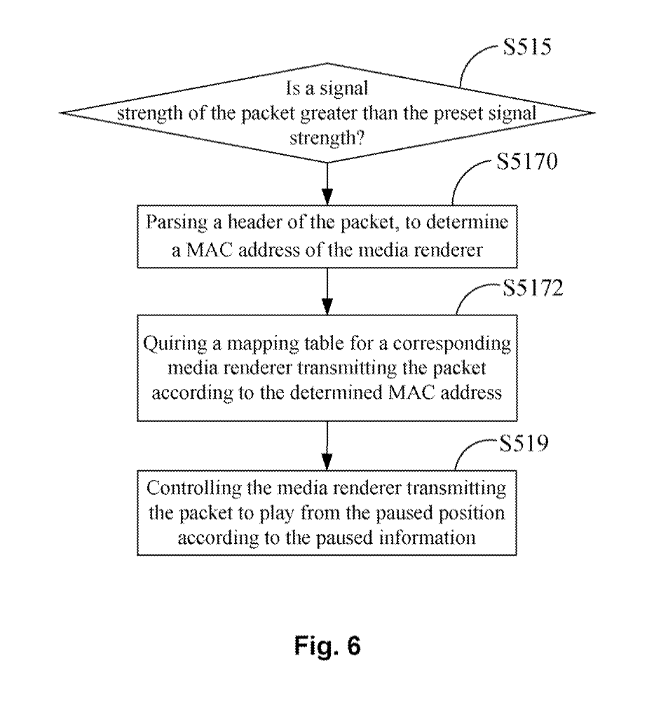

FIG. 6 is a detailed flowchart of step S517 in FIG. 5.

In step S5170, the remote control module 100 parses a header of the packet, to determine a MAC address of the media renderer transmitting the packet. In this embodiment, a determined MAC address is 0x0000BD1268ED1C12.

In step S5172, the remote control module 100 queries a mapping table stored therein for a corresponding media renderer transmitting the packet according to the determined MAC address. In this embodiment, the corresponding media renderer transmitting the packet is the second media renderer 120.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A remote control device for controlling a media renderer, comprising:
a wireless personal area network module, comprising:
a receiving module for receiving a packet from the media renderer; and
a determining module for determining whether the remote control device roams according to the packet; and
a wireless local area network module connected to the wireless personal network module, comprising:
a control module for controlling another media renderer to play from a paused position according to the paused information when the remote control device roams.

2. The remote control device in accordance with claim 1, wherein the wireless personal area network module further comprises a first switching module for transmitting a short-distance switch-on instruction or a short-distance switch-off instruction.

3. The remote control device in accordance with claim 1, wherein the wireless local area network module further comprises:
a second receiving module for receiving another packet from the another media renderer, and for obtaining media information from the second packet;
a parsing module for parsing the media information obtained by the second receiving module;
a inquiring module for determining a media renderer transmitting the packet according to the media information; and
a second switching module for transmitting a long-distance switch-on instruction or a long-distance switch-off instruction.

4. The remote control device in accordance with claim 1, further comprising a storage module for storing the media information and the paused information.

5. The remote control device in accordance with claim 4, wherein the storage module comprises a mapping table, the mapping table listing a unique device name field, a device name field, and a medium access address field.

6. An automatic switching method applicable to a remote control device, comprising:
receiving a packet from a media renderer;
determining whether the remote control device roams according to the packet;
storing paused information of the media renderer if the remote control device roams; and
playing from a paused position according to the paused information of another renderer.

7. The automatic switching method in accordance with claim 6, further comprising continuing receiving a following packet by the remote control device if the remote control device does not roam.

8. The automatic switching method in accordance with claim 6, wherein the step of determining whether the remote control device roams according to the packet comprises:
determining whether the remote control device leaves an original region according to the packet;
determining whether to switch off the first media renderer if the remote control device leaves the first region; and
determining whether the remote control device roams to a new region if the first media renderer is switched off.

9. The automatic switching method in accordance with claim 8, wherein the step of determining whether the remote control device leaves an original region according to the packet comprises detecting whether signal strength of the packet is less than a preset signal strength.

10. The automatic switching method in accordance with claim 9, wherein the step of determining whether the remote control device leaves an original region according to the packet further comprises detecting the remote control device leaves the first region if the signal strength of the packet is less than the preset signal strength.

11. The automatic switching method in accordance with claim 10, wherein the step of determining whether the remote control device leaves an original region according to the packet further comprises receiving a following packet if the signal strength of the packet is not less than the preset signal strength.

12. The automatic switching method in accordance with claim 8, wherein the step of determining whether the remote control device switches off the first media renderer if the remote control device leaves the original region comprises:
pausing the first media renderer; and
switching off the first media renderer.

13. The automatic switching method in accordance with claim 8, wherein the step of determining whether the remote control device roams to a new region if the first media renderer is switched off comprises receiving another packet.

14. The automatic switching method in accordance with claim 13, wherein the step of determining whether the remote control device roams to a new region if the first media renderer is switched off further comprises detecting whether signal strength of the another packet is greater than a preset signal strength.

15. The automatic switching method in accordance with claim 14, wherein the step of determining whether the remote control device roams to a new region if the first media renderer is switched off further comprises detecting the remote control device roams to the new region if the signal strength of the another packet is greater than the preset signal strength.

16. The automatic switching method in accordance with claim 15, further comprising continuing receiving a following packet if the signal strength of the packet is not greater than the preset signal strength.
